(19) United States
(12) Patent Application Publication
(10) Pub. No.: US 2005/0085367 A1
(43) Pub. Date: Apr. 21, 2005

(54) Machine with a coupling member to connect two stations which punch and slit corrugated cardboard blanks and then erect them

(76) Inventors: Stefan Jornborn, Jonkoping (SE); Tommy Rydberg, Habo (SE)

Correspondence Address: Donald S. Dowden;Cooper & Dunham, 1185 Avenue of the Americas, New York, NY, 10036, US

(21) Appl. No.: 10/504,222

(22) PCT Filed: Feb. 12, 2003
(86) PCT No.: PCT/IB03/00485

(30) Foreign Application Priority Data
Feb. 13, 2002 (DK) PA 2002 00216

(51) Int. Cl. B31F 1/00

(52) U.S. Cl. 493/431

(57) ABSTRACT

A machine for punching out and optionally slitting corrugated cardboard blanks from a web (2) of corrugated cardboard while simultaneously applying folding lines onto said corrugated cardboard blanks (2a). The machine includes two interacting punching tools, such as two interacting cylinders (4, 5), the punching, slitting and folding line tools being mounted on said cylinders. A delivery unit (7, 7a) is mounted immediately after the two interacting cylinders (4, 5) said delivery unit (7, 7a) being adapted to be connected to an erection module (1b) by means of a coupling member (10, 15). The erection module (1b) is adapted to erect the plane corrugated cardboard blanks (2a) punched out and provided with folding lines into a permanent or semipermanent three-dimensional shape. In this manner a significant logistics problem is solved, said problem concerning the moving of corrugated cardboard blanks punched out, but not yet erected. In addition, the machine is very reliable.

### TECHNICAL FIELD

The invention relates to a machine for punching out and optionally slitting corrugated cardboard blanks from a web of corrugated cardboard while simultaneously applying folding lines onto said corrugated cardboard blanks, and where the machine includes two interacting punching tools, such as a plane punch provided with an upper and a lower tool or two interacting cylinders, where said punching, slitting and folding line tools are mounted on said two interacting cylinders.

### BACKGROUND ART

Machines are known for punching out and/or slitting corrugated cardboard blanks from webs of corrugated cardboard. If desired, these machines can also apply folding lines onto the cardboard blanks. Typically, these machines are placed at cardboard mills producing for customers, such as factories, producing articles to be packed.

Furthermore, machines for erecting corrugated cardboard blanks are known, said machines providing the blanks with their permanent or semipermanent three-dimensional shape in such a manner that said blanks are ready to be filled. Typically, these machines are placed at article-producing factories where the final step of an article-producing process results in a completely packed article.

However, it is not an optimum solution to place the punching machines at one location, such as at a cardboard mill, and the folding machines at another location, such as at an article-producing factory, because a rather comprehensive logistics is involved in packing the corrugated cardboard blanks at the cardboard mill and carrying said blanks to the article-producing factory.

### BRIEF DESCRIPTIONS OF THE INVENTION

The object of the invention is to provide a machine of the above type which solves the above logistics problem and which at the same time is very reliable.

The machine according to the invention is characterised in that a delivery unit, such as a conveyor belt or a chute, is mounted immediately after the interacting upper and lower tools or the two interacting cylinders, and that said delivery unit is adapted to be connected to an erection module by means of a coupling member, said erection module erecting the plane corrugated cardboard blanks punched out and provided with folding lines into a permanent or semipermanent three-dimensional shape in which the resulting corrugated cardboard articles are ready to be filled with products. As a result logistic advantages are obtained as it is possible to completely avoid a packing and a sending of the corrugated cardboard blanks punched out to the product-producing factory. The coupling member has the effect that the punching out of the corrugated cardboard blanks is carried out adjacent the erection module and at the article-producing factory. Besides, the punching tools need not be manufactured at the same factory as the erection module.

The coupling member may according to the invention include a collecting compartment for a temporary collecting of the corrugated cardboard blanks arriving from the delivery unit, said collecting compartment for instance being shaped as an upwardly open box with lateral guide rails. As a result, a suitable buffer for corrugated cardboard blanks punched out is obtained in case the erection module cannot operate at the same speed as the punching tools.

Moreover, the coupling member may according to the invention include a transferring means optionally provided with a program controlling means, viz. a “communication means”, and transferring one or more corrugated cardboard blanks at a time from the delivery unit of the collecting compartment to the feeding end of the erection module. As a result, the coupling member can, if necessary, transfer bundled corrugated cardboard blanks.

The transferring means of the coupling member may according to the invention be adapted to lift/grip/push and move corrugated cardboard blanks from the delivery unit or the collecting compartment to the feeding end of the erection module, where said corrugated cardboard blanks are released/left The resulting transfer of the corrugated cardboard blank(s) to the feeding end of the erection module is particularly reliable.

In addition, the transferring means of the coupling member may according to the invention be provided with a gripping member for instance at a free end thereof, said gripping member for instance being in form of a suction cup. This embodiment turned out to be particularly reliable because then it is guaranteed that the transferring means does not leave a mark on the corrugated cardboard blank.

Furthermore, the transferring means of the coupling member may according to the invention be adapted to position the corrugated cardboard blank at a specific location in a desired manner in connection with the release of said corrugated cardboard blank at the feeding end of the erection module. In this manner it is ensured that the corrugated cardboard blank can be transferred to the erection module at any necessary desired angle.

Moreover, the collecting compartment of the coupling member may according to the invention form part of a level-controlling unit controlling the height of the stack of corrugated cardboard blanks temporarily placed in said collecting compartment. In this manner it is ensured that a limit applies to the number of punched out corrugated cardboard blanks stored and waiting in the collecting compartment. When too many corrugated cardboard blanks are waiting in the collecting compartment, the level-control unit can stop the punching tools temporarily.

Finally, the coupling member may according to the invention include coupling means, such as hook members, adapted to keep together the above delivery unit and the erection module as well as the guide rails, if any, optionally in a relatively tight relationship, said guide rails allowing the corrugated cardboard blanks delivered in or at the delivery unit to slide directly or almost directly into the feeding end of the erection module. As a result, the ready machine is relatively compact.

### BRIEF DESCRIPTION OF THE DRAWINGS

The invention is explained in detail below with reference to the accompanying drawing, in which

FIG. 1 is a side view of an embodiment of a machine according to the invention,

FIG. 2 corresponds to FIG. 1, but where the coupling member includes a collecting compartment for corrugated cardboard blanks, and

FIG. 3 shows an embodiment of the machine where the coupling member includes a conveyor.

### BEST MODE FOR CARRYING OUT THE INVENTION

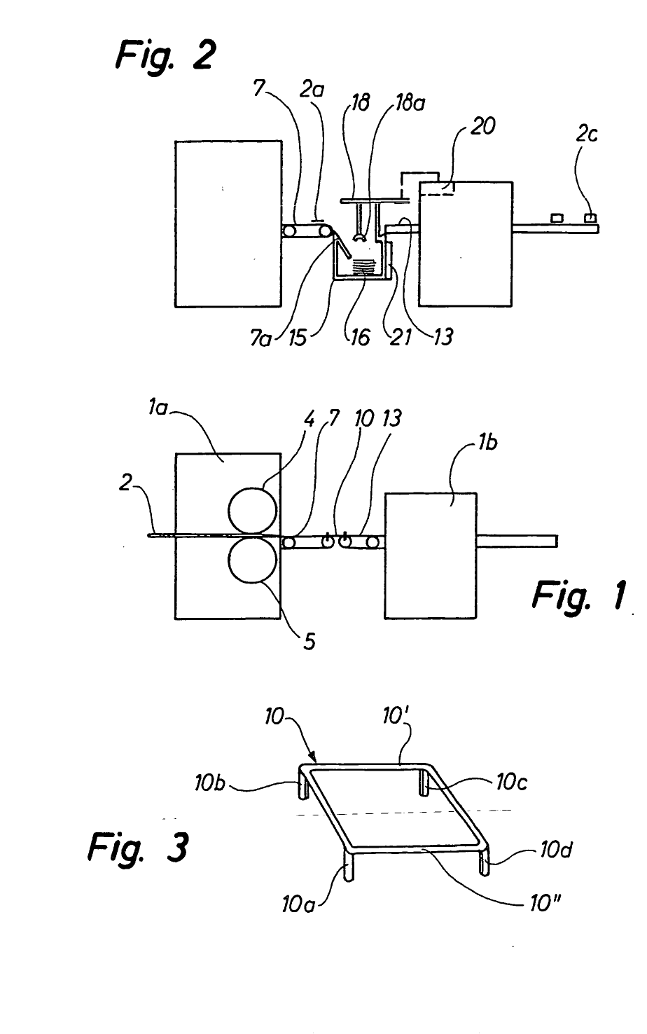

The machine of FIG. 1 includes two sections 1a and 1b. The machine section 1a is adapted to punch out and optionally slit corrugated cardboard blanks 2a from a web 2 of corrugated cardboard while simultaneously applying folding lines onto said corrugated cardboard blanks. The machine section 1a includes two interacting punching tools, such as for instance two interacting cylinders 4, 5, where punching, slitting and/or folding line tools not shown are mounted on said cylinders. These two interacting cylinders 4 and 5 can instead be a plane punch not shown including upper and lower tools for processing the web of corrugated cardboard blanks. A delivery unit 7 is mounted immediately after the two interacting cylinders 4, 5 viz. optionally the interacting upper and lower tools. The delivery unit 7 is in the present case formed by a conveyor belt, but it can be or include other members, such as a chute. The delivery unit 7 is adapted to be connected to the machine section 1b by means of a coupling member 10 provided with coupling means. The machine section 1b is formed by an erection module for erecting the plane corrugated cardboard blanks punched out and provided with folding lines in such a manner that said corrugated cardboard blanks is provided with a permanent or semipermanent three-dimensional shape. Then the resulting corrugated cardboard articles 2c can be filled with products for instance by means of a succeeding module. The machine section 1b, viz. the erection module, can be of any structure known per se provided it is capable in a reliable and fast manner of carrying and erecting the corrugated cardboard blanks arriving.

The coupling member 10 includes coupling means. FIG. 3 shows how these coupling means can be formed by hook members 10a, 10b, 10c and 10d, and the remaining coupling member can be formed by two parallel guide rails 10′ and 10″. In FIG. 1, the feeding end of the erection module is provided with an endless conveyor belt 13, and then the coupling member 10 interconnects the two conveyor belts 7 and 13, coupling eyes not shown being provided on the conveyor belt 13 and allowing the hook members 10a to 10d to interact.

FIG. 2 shows how the coupling member further can include a collecting compartment 15 for a temporary collecting of the corrugated cardboard blanks 2a arriving from the delivery unit 7. The collecting compartment can be shaped as an upwardly open box with preferably vertical, lateral guide rails not shown form the corrugated cardboard blanks. When the corrugated cardboard blanks re released from the machine section 1, the conveyor 7 carries said blanks to the right whereafter they slide, optionally via a chute, downwards into the collecting compartment 15, in which they form a stack 16. These stacked blanks can be moved further because the coupling member 15 also includes a transferring means 18 optionally equipped with a program controlling means, viz. a “communication means” 20 which is for instance secured to the erection module. This transferring means 18 is adapted to transfer one or more corrugated cardboard blanks at a time from the collecting compartment 15 to the feeding end 13 of the erection module 1b. The program controlling means renders it possible to set the transferring means 18 so as to very carefully feed corrugated cardboard blanks through said feeding end into the coupling member 1b at the exact speed which is the optimum operating speed of said coupling member 1b. In FIG. 2, the transferring means 18 is mounted directly on the collecting compartment. Several parts of the transferring means 18 can, however, also be mounted on the erection module 1b.

The transferring means 18 of the coupling member is usually adapted to lift/grip/push and move corrugated cardboard blanks from the delivery unit or the collecting compartment to the feeding end 13 of the erection module 1b, where the corrugated cardboard blanks in question is released/left so as to be fed into the erection module in another manner, such as by means of the feeding conveyor 13 shown in FIG. 13.

The transferring means of the coupling member is usually very easily movable. The free end 18a of the transferring means is usually provided with a gripping member, such as a pair of tongs or a member provided with one or more suction cups 18a. In connection with the release of each corrugated cardboard blank at the erection module, the transferring means 18a is adapted to position said blank in an advantageous manner at the feeding end 13 of said erection module 1b, optionally in such a manner that said blank forms a predetermined angle with said feeding end 13.

FIG. 2 shows how the collecting compartment 15 of the coupling member can form part of a level-controlling unit 21 controlling the height of the stack 16 of corrugated cardboard blanks temporarily placed in said collecting compartment 15.

The embodiment of the coupling member 10 shown in FIG. 3 is particular in allowing corrugated cardboard blanks delivered in or at the delivery unit 7 to slide directly onto the feeding end 13 of the erection module 1b in order to be further processed, such as folded, erected etc.

The invention may be modified in many ways without thereby deviating from the scope of the invention. Thus a light-sensitive contact not shown and an opposing light source can be arranged in connection with the transferring means 18 of the coupling member. These members serve to stop or activate the transferring means 18, said contact being activated when a corrugated cardboard blank 2a just punched out and approaching the transferring means refracts a light beam from the light source.

1. A machine for punching out corrugated cardboard blanks (2a) from a web (2) of corrugated cardboard while simultaneously applying folding lines onto said corrugated cardboard blanks, and where the machine includes two interacting punching tools, characterised in that a delivery unit is mounted immediately after the interacting tools, and that the delivery unit (7) is adapted to be connected to an erection module (1b) by means of a coupling member (10, 15), said erection module erecting the corrugated cardboard blanks punched out and provided with folding lines into corrugated cardboard articles ready to be filled with products.

2. Machine according to claim 1 wherein the coupling member includes a collecting compartment (15) for a temporary collecting (16) of the corrugated cardboard blanks arriving from the delivery unit (7), said collecting compartment being shaped as an upwardly open box with lateral guide rails.

3. Machine according to claim 1 wherein the coupling member (15) includes a transferring means (18,18a) optionally provided with a program controlling means (20) for transferring one or more corrugated cardboard blanks at a time from the delivery unit (7) of the collecting compartment (15) to the feeding end (13) of the erection module (1b).

4. A machine according to claim 1 wherein the transferring means (18a) of the coupling member is adapted to move corrugated cardboard blanks from the delivery unit (7) or the collecting compartment (15) to the feeding end (13) of the erection module, where said corrugated cardboard blanks are released.

5. Machine according to one or more of the claim 1 wherein the transferring means (18) of the coupling member is provided with a gripping member and a light-sensitive contact is provided for activating said transferring means when a corrugated cardboard blank approaches said transferring means.

6. Machine according to one or more of the claim 1 wherein the transferring means (18a) of the coupling member is adapted to position the corrugated cardboard blank in a desired manner at the feeding end (13) of the erection module when said corrugated cardboard blank is released.

7. Machine according to one or more of the claim 1 wherein the collecting compartment of the coupling member includes a level-controlling unit (21) for controlling the height of the stack (16) of corrugated cardboard blanks placed in the collecting compartment (15).

8. Machine according to one or more of the claim 1 wherein the coupling member includes hook members (10a, 10b, 10c, 10d), which are adapted to keep together the delivery unit (7) and the erection module (1b), said guide rails allowing the corrugated cardboard blanks delivered in or at the delivery unit (7) to slide into the feeding end (13) of the erection module (1b).

9. Machine according to claim 1, comprising means for slitting the cardboard blanks.

10. Machine according to claim 1 wherein the punching tools comprise a plane punch formed by upper and lower tools.

11. Machine according to claim 1, wherein the punching tools comprise two interacting cylinders.

12. Machine according to claim 1, wherein the delivering unit comprises a conveyor belt.

13. Machine according to claim 1, wherein the delivery unit comprises a chute.
